(19) United States
(12) Patent Application Publication
(10) Pub. No.: US 2011/0099481 A1
(43) Pub. Date: Apr. 28, 2011

(54) ANCHORING A REMOTE ENTITY IN A LOCAL DISPLAY

(75) Inventors: THOMAS F. BITONTI, CARY, NC (US); WENDELL J. BOUKNIGHT, JR., CLAYTON, NC (US); JOHN F. MALLOY, APEX, NC (US); DANA L. PRICE, CARY, NC (US)

(73) Assignee: INTERNATIONAL BUSINESS MACHINES CORPORATION, ARMONK, NY (US)

(21) Appl. No.: 12/605,478

(22) Filed: Oct. 26, 2009

(51) Int. Cl. G06F 3/048; G06F 15/16

(52) U.S. Cl. 715/740

(57) ABSTRACT

A remote desktop application displays a remote graphical interface on a local computer screen. A remote entity, for example, a taskbar, is anchored along an edge of the remote graphical interface on the local computer screen. The anchored taskbar and the remote interface are displayed on the local computer screen such that the remote entity is in a viewable position on the local computer screen. The anchoring can be turned on and off in response to a user selection of a control. The control can be provided to position the remote entity along a bottom, top, left, or right edge in response to a user selection.

### BACKGROUND

The present invention relates to remote desktop applications that display the graphical interface of another computer, and more specifically, to anchoring a remote entity, such as a taskbar in the local display of a remote graphical interface.

Users of computer systems frequently have more than one personal and/or business computer. Sometimes it becomes necessary or desirable to access one of those computers when it is at a different physical location. For example, if a user is in their office or on a business trip, it may become necessary to do something on their personal home computer, such as, view a utility bill or read personal email. The user may also find it advantageous or necessary to spread their work over several different computers, also in several different locations. Additionally, if the user is unable to go to their office, it may be necessary to complete work related tasks regardless of their personal condition. These are, among others, the kind of situations where the use of a remote desktop program can come into play. With a remote desktop program, a user will be able to see and work with remote computers as if they were their own local machines.

A remote desktop application displays the graphical interface of a remote computer on a local screen. The remote desktop application allows use of the local mouse and keyboard to control the remote computer. Thus, a user can work on a remote computer, as if sitting in front of it. It is also common to use a remote desktop application to control a machine with one operating system from a machine with a different operating system. The applications run on the remote computer and only the keyboard input, mouse input, and graphical interface content are transmitted over a network from the local computer.

FIGS. 2A and 2B show a remote graphical interface in a window on a local computer screen 100 as is known in the prior art. FIG. 2A shows a first portion/page 102 of the remote graphical interface while FIG. 2B shows the remaining portion/page 104 of the remote graphical interface. In order for the user of the local computer to see the remote taskbar 106 at the bottom of the remaining portion/page 104 on the local computer screen 100, it is necessary to scroll down the window on the local computer screen 100. Doing so causes at least some of the material in the first portion/page 102 to scroll out of the viewable space on the local computer screen 100. Thus, in order to operate on the taskbar 106, it is necessary to lose sight of at least part of the remote interface in the window on the local computer screen 100.

For example, while viewing content at the top of the remote interface on the local computer screen 100, if the user wants to select an action from the taskbar 106, such as starting another application, it is necessary to scroll down to the edge of the local computer screen 100 where the taskbar is displayed, select the taskbar action, and then scroll back up to the top of the remote interface on the local computer screen 100.

### BRIEF SUMMARY

According to one embodiment of the present invention a computer implemented method for a remote desktop application displays a remote interface on a local display. It is determined if the remote interface can be entirely displayed within a single view on the local display. If not, a remote entity is anchored in the local display, such that the remote entity remains in a viewable location on the local display as the remote interface is scrolled by a user.

According to an embodiment of the present invention, a computer system displays a remote interface on a local display for a remote desktop application. The system comprises a remote interface evaluator operative to determine if the remote interface can be entirely displayed within a single view on the local display. If the remote interface is determined to be larger than said single view, an anchor control anchors a remote entity in a viewable location on the local display. Thus, the remote entity remains viewable on the local display as a user scrolls the remote interface.

According to an embodiment of the present invention, a computer program product for a remote desktop application displays a remote interface on a local display. A computer readable storage medium having computer readable program code embodied therewith is configured to determine if the remote interface can be entirely displayed within a single view on the local display. If not, computer readable program code is configured to anchor a remote entity in the local display, wherein the remote entity remains in a viewable location on the local display as the remote interface is scrolled by a user.

### BRIEF DESCRIPTION OF THE SEVERAL VIEWS OF THE DRAWINGS

FIG. 1 is a hardware diagram that implements an embodiment of the present invention;

FIGS. 2A and 2B illustrate a remote graphical interface in a window on a local computer screen;

FIG. 3 illustrates an embodiment of the present invention; and

FIG. 4 illustrates a flow chart of an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create an implementation of the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

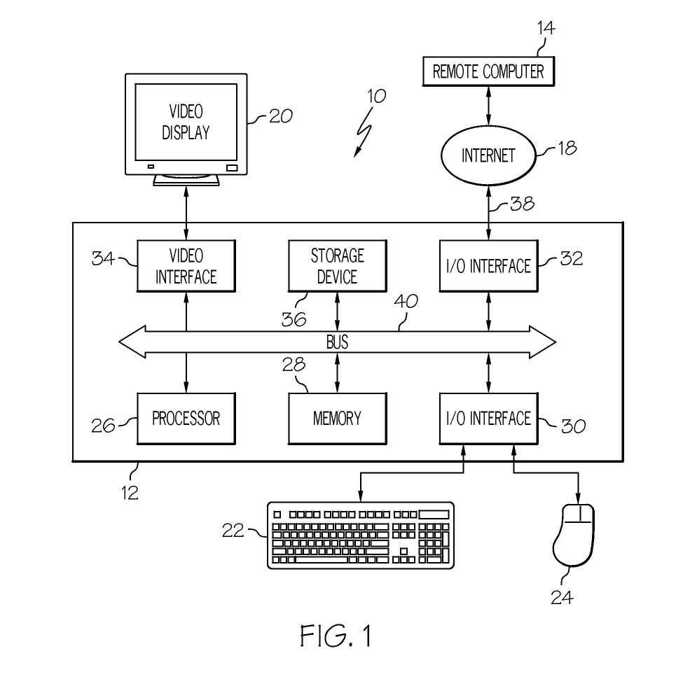

FIG. 1 is an example of a computer system 10 suitable for executing computer software for anchoring a taskbar in a remote desktop program window in accordance with the techniques described above. Other processing devices which are suitable for executing the software can be a wireless telephone, personal assistant device (PDA), portable computer, smart remote control device, or any other processing devices that can execute such software.

The processing device as shown in FIG. 1 is a computer system 10 of a type that executes under a suitable operating system installed on the computer system 10, and may be thought of as comprising various software code for achieving the particular steps of the aforementioned methods of anchoring a remote graphical interface taskbar in a local display.

The components of the computer system 10 include a local computer 12, a keyboard 22, mouse 24, and a video display 20. The computer 12 includes a processor 26, a memory 28, input/output (I/O) interfaces 30 and 32, a video interface 34, and a storage device 36. A remote computer 14 may comprise a similar makeup as described for local computer 12.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to video display 20 and provides video signals for display on the video display 20. User input to operate the computer 12 is provided from the keyboard 22 and mouse 24 (and through a remote desktop program, computer 14). The storage device 36 can include a disk drive or any other suitable storage medium. Each of the components of the computer 12 is connected to an internal bus 40 that includes data, address, and control buses, to allow components of the computer 12 to communicate with each other via the bus 40. The computer system 10 can be connected to one or more other similar computers (including computer 12) via an input/output (I/O) interface 32 using a communication channel 38 to a network, represented as the Internet 18.

The computer software may be recorded on a computer readable storage medium, in which case the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

“Remote desktop application” is used herein to indicate a type of software application that provides a user of a local computer with a graphical interface to another (remote) computer. The local computer has its own graphical interface which may, or may not, be similar to the graphical interface of the remote computer. “Remote interface” will be used to indicate the graphical interface of the remote computer, while “remote interface on a local display” will be used when referring to the graphical interface of the remote computer as seen on the local computer.

Similarly, the remote computer and the local computer each have their own graphical interfaces with distinct classes of entities such as, taskbars displayed by their respective graphical interfaces. Thus, “remote” will be used with entity or taskbar to indicate the entity or taskbar of the remote computer on the remote computer. The terms “remote entity on a local display” or “remote taskbar on a local display” will be used when referring to the entity or taskbar of the remote computer as displayed within the graphical interface of the remote computer but as seen on the local computer (as opposed to the local taskbar on the graphical interface of the local computer). Although not illustrated, the present invention may be applied to additional remote classes of entities (remote entities) such as a clock or a process monitor. Since a remote interface is mapped to a local display in a manner that retains the positioning of any such entities relative to their location on the remote interface, the present invention may be applied to such other entities.

The remote desktop application provides the user access to the remote interface using the local keyboard and mouse. The remote interface on the local display allows the user to interact with the remote interface through a network, such as, the Internet, a local area network, or a wide area network. By manipulating the remote interface on the local computer, a user is able to access content on the remote computer. However, if it is determined that the remote interface cannot be displayed entirely on a single view of the local display, the present invention may be used to anchor any entities in a viewable position while a user scrolls through the interface.

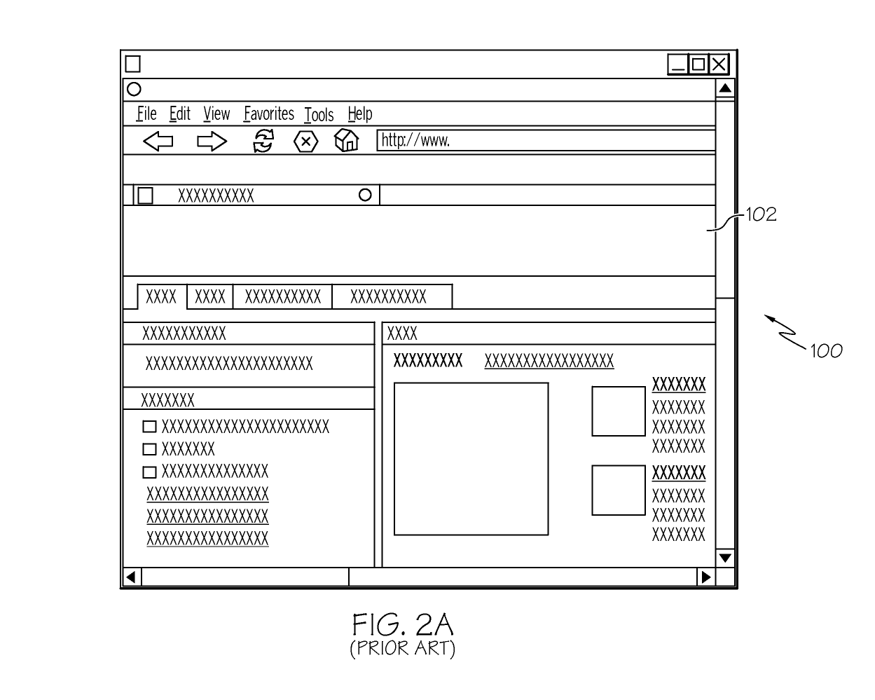

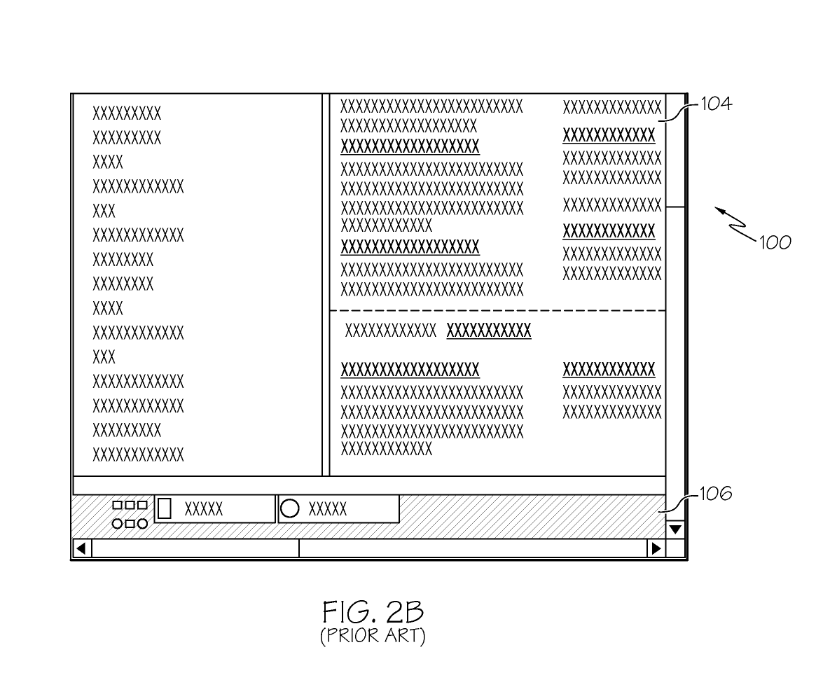

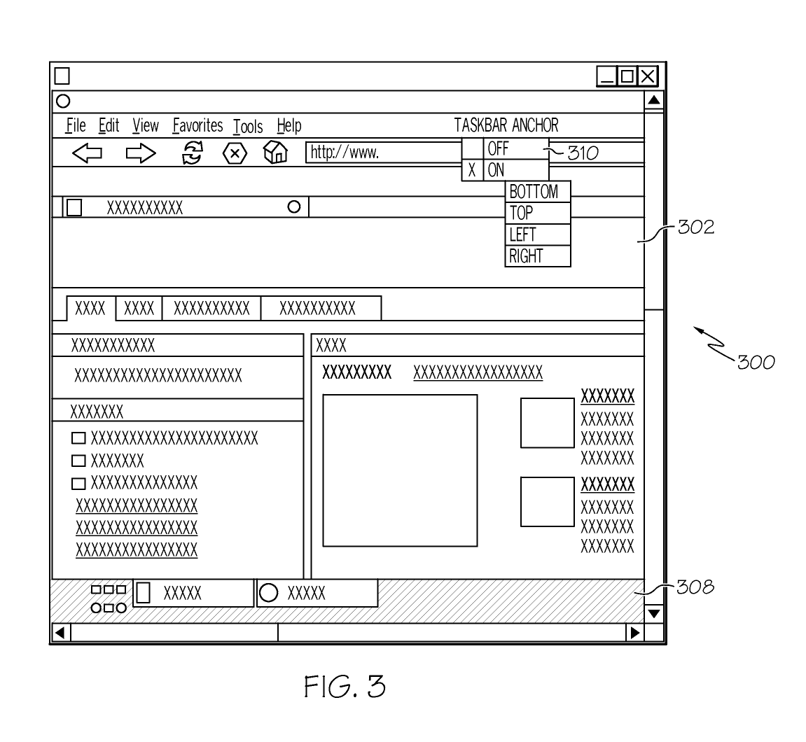

Referring now to FIG. 3, an embodiment of the present invention is illustrated. A remote interface and a remote taskbar are displayed on a local display 300. As shown in FIG. 3, the remote taskbar is identified as a remote taskbar on a local display 308 and is anchored to an edge (the bottom edge as shown in FIG. 3). The remote interface is identified as a remote interface on a local display 302 (corresponding to the first portion 102 of FIG. 2A). As the viewable area of the remote interface on the local display 300 changes (i.e., the user scrolls up or down), the remote taskbar on the local display 308 remains anchored to the edge of the local display 300. Thus, the functions and controls of the remote taskbar on a local display 308 remain at the user's disposal.

The characteristics of the remote taskbar, including size and content, are transmitted and maintained separately from the other displayable portions of the remote interface. These characteristics are used by the operating system of the remote computer when the remote taskbar is moved around and/or hidden, thereon. Thus, when using a remote desktop application, the remote computer 14 (FIG. 1) would send two separate content streams to the local computer screen, one being the content of the remote interface itself, and the second being the remote taskbar (and/or any other classes of entities) to facilitate the anchoring of the remote taskbar on the local display 300. To implement the present invention, the remote desktop application displaying the remote interface on a local display will place the remote taskbar in a fixed position on the local display, and use the remaining viewable area of the local computer screen to display remote graphical interface content. The remote desktop application would be modified to provide this capability utilizing components on both the local and remote computers (the remote computer is running the server application while the local computer is running the client application).

In an embodiment of the present invention an option may be provided to allow customization by the user. The default behavior may be to always provide anchoring of a remote entity, such as a taskbar. An option could include a checkbox or drop-down menu 310 (FIG. 3) for a given instance of the remote desktop application that would allow the user to specify whether this functionality is desired for this session. If selected, the remote entity/taskbar on the local display would be anchored at an edge of the remote interface on the local display. If not selected, the traditional method of displaying the remote entity/taskbar at the edge of the remote interface would be used. The entity/taskbar could optionally be positioned along the bottom, top, left, or right edge at the user's option.

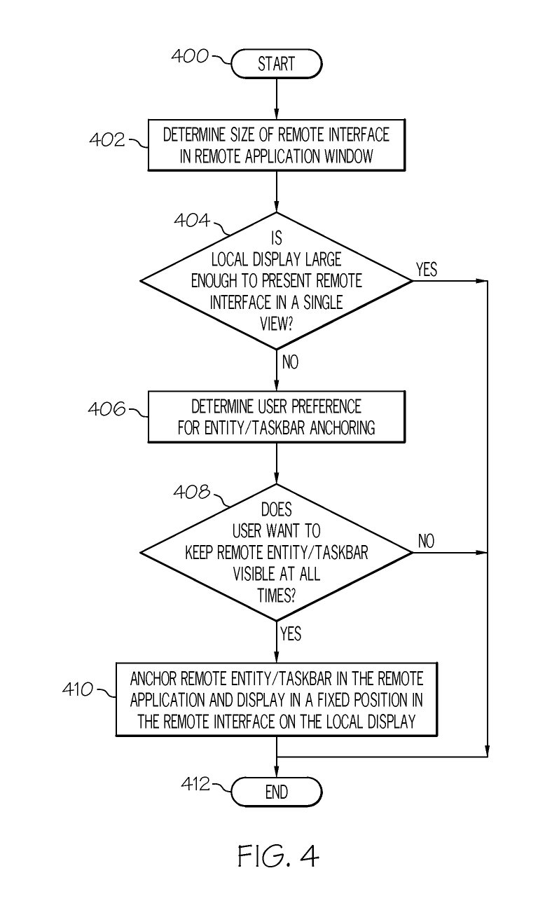

Referring to FIG. 4, a flow chart illustrates an embodiment of the invention. At block 400, the present invention starts, and the size of the remote interface is determined at block 402. For example, this could be the display size of the first portion/page 102 plus the remaining portion/page 104, as shown in the prior art FIGS. 2A and 2B. At decision block 404, it is determined whether the local display is large enough to present the remote interface in a single view, thereon. If the response to decision block 404 is yes (the space available on the local display is sufficient for a single view), the remote interface and the remote entity/taskbar will be displayed locally in the same position as remotely, and the present invention ends at block 412.

If the response to decision block 404 is no (the space available on the local display is insufficient for a single view), the present invention determines the user's preference for entity/taskbar anchoring at block 406. As discussed above, this could be based on a default or a user selected option.

At decision block 408, it is determined whether the user wants to keep the remote entity/taskbar visible at all times. If the response to decision block 408 is no, the entity/taskbar is displayed in its default location (wherever it shows up in the remote desktop), and the process ends at block 412. If the response to decision block 408 is yes, the entity/taskbar is anchored in the remote application and is displayed in a fixed position in the remote interface on the local display. The process ends at block 412.

Having thus described the invention of the present application in detail and by reference to embodiments thereof, it will be apparent that modifications and variations are possible without departing from the scope of the invention defined in the appended claims.

What is claimed is:

1. A computer implemented method for a remote desktop application, the remote desktop application displaying a remote interface on a local display, comprising:
determining if the remote interface can be entirely displayed within a single view on the local display; and
if said remote interface is determined to be larger than said single view, anchoring a remote entity in the local display, wherein said remote entity remains in a viewable location on the local display as the remote interface is scrolled by a user.

2. The computer implemented method of claim 1, further comprising providing a control to allow said user to turn said anchoring off.

3. The computer implemented method of claim 1, wherein anchoring said remote entity comprises anchoring a remote taskbar along an edge of the local display.

4. The computer implemented method of claim 3, further comprising providing an optional control to allow said user to position said anchored taskbar along a user selected edge of the local display.

5. A computer system for a remote desktop application, the remote desktop application displaying a remote interface on a local display, comprising:
a remote interface evaluator operative to determine if the remote interface can be entirely displayed within a single view on the local display; and
if said remote interface is determined to be larger than said single view, an anchor control anchors a remote entity in a viewable location on the local display, wherein said remote entity remains viewable on the local display as a user scrolls the remote interface.

6. The system of claim 5, further comprising a control for a user to turn said anchoring off.

7. The system of claim 5, wherein said anchor control anchors a remote taskbar along an edge of the local display.

8. The system of claim 7, further comprising an optional control for positioning said anchored taskbar along a user selected edge of the local display.

9. A computer program product for a remote desktop application, the remote application displaying a remote interface on a local display, the computer program product comprising:
a computer readable storage medium having computer readable program code embodied therewith, the computer readable program code comprising:
computer readable program code configured to determine if the remote interface can be entirely displayed within a single view on the local display; and
if not, computer readable program code configured to anchor a remote entity in the local display, wherein said remote entity remains in a viewable location on the local display as the remote interface is scrolled by a user.

10. The computer program product of claim 9, further comprising computer readable program code configured to turn said anchoring off in response to a user selection.

11. The computer program product of claim 9, wherein computer readable program code configured to anchor said remote entity in the local display further comprises anchoring a remote taskbar along an edge of the local display.

12. The computer program product of claim 11, further comprising computer readable program code configured to optionally anchor said remote taskbar along a user selected edge of the local display.
